(19) United States
(12) Patent Application Publication
(10) Pub. No.: US 2018/0340553 A1
(43) Pub. Date: Nov. 29, 2018

(54) PRESSURE BOOSTER FOR DRIVING HYDRAULIC TOOLS

(71) Applicant: TKR SPEZIALWERKZEUGE GMBH, Gevelsberg (DE)

(72) Inventors: MARTIN ZURMUEHLEN, BOCHUM (DE); HEINZ ENRIQUEZ, WITTEN (DE)

(21) Appl. No.: 15/989,432

(22) Filed: May 25, 2018

(30) Foreign Application Priority Data
May 29, 2017 (DE) 10 2017 111 657.5

(51) Int. Cl. F15B 3/00; H02K 7/18

(52) U.S. Cl. CPC F15B 3/00; F01D 15/10; H02K 7/1823

(57) ABSTRACT

A pressure booster for driving hydraulic tools has a gas or air pressure-driven pneumatic unit with a system line attaching to a compressed air inlet. An hydraulic unit is connected to the pneumatic unit. The hydraulic unit has a hydraulic connection to the fluid-tight connection of the hydraulic tool to the hydraulic unit. To provide a pressure booster which enables the use of electrically operated functional components independent of an external electrical connection, it is provided that a compressed air generator connected to the compressed air inlet is connected to an internal electrical consumer and/or a connection unit for connecting an external electrical consumer.

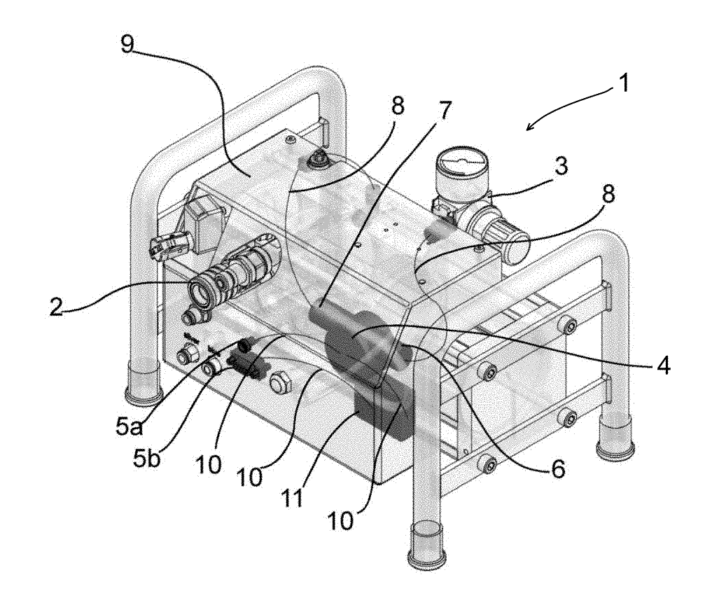

### CROSS-REFERENCE TO RELATED APPLICATION

This application claims the priority, under 35 U.S.C. § 119, of German patent application DE 10 2017 111 657.5, filed May 29, 2017; the prior application is herewith incorporated by reference in its entirety.

### BACKGROUND OF THE INVENTION

### Field of the Invention

The invention pertains to a pressure booster for driving hydraulic tools with a gas or air pressure-driven pneumatic unit with a system line connecting to a compressed air inlet and a hydraulic unit connected to the pneumatic unit. The hydraulic unit has a hydraulic connection for the fluid-tight connection of the hydraulic tool to the hydraulic unit.

Pressure boosters are known in many embodiments in the prior art. Such devices serve, for example, to drive hydraulically driven hydraulic tools, which are used for die cutting, riveting, clinching or joining, among other things. The pressure booster can, for example, convert a pneumatic low pressure in the range of 2-10 bar, for instance, to a hydraulic high pressure of 100-600 bar. The higher hydraulic pressure can be used to drive working pistons of the hydraulic tools that are connectable to the pressure booster.

Pressure boosters of the aforementioned type are employed inter alia in vehicle repair shops, where they are used, for example, to drive hydraulic punch presses and riveting equipment employed for vehicle repair. Here the pressure boosters are supplied via the compressed air lines typically present in vehicle repair shops, which can be coupled directly to the pressure boosters. A constant, high pneumatic pressure can then ensure reliable operation of the pressure booster and of a hydraulic tool connected to the pressure booster.

A compressed air supply is fundamentally sufficient for operating pressure boosters. For the use of additional electric functional components, such as lighting, an electric display unit or electrically operated sensors, however, it is necessary to provide the pressure booster with an electrical connection as well, wherein in any case a corresponding electric power supply must also be present at the place of use, thus limiting the application. Furthermore, with international use, an electrical connection adapted for the respective country must be provided, making international sales and distribution more expensive and difficult.

### SUMMARY OF THE INVENTION

It is accordingly an object of the invention to provide a pressure booster which overcomes the above-mentioned and other disadvantages of the heretofore-known devices and methods of this general type and which is enabled to use electrically operated functional components independent of an external electrical connection.

With the foregoing and other objects in view there is provided, in accordance with the invention, a pressure booster for driving a hydraulic tool, the pressure booster comprising:

a gas or air pressure-driven pneumatic unit with a system line connected to a compressed air inlet;

a hydraulic unit connected to said pneumatic unit, said hydraulic unit having a hydraulic connection for a fluid-tight connection of the hydraulic tool to said hydraulic unit;

a compressed air generator connected to said compressed air inlet, said generator being connected to one or both of an internal electrical consumer or a connection unit for connecting an external electrical consumer.

A defining feature of the inventive pressure booster is a compressed air generator connected to the compressed air inlet, said generator being connected to an internal electrical consumer and/or a connection unit for connecting an external electrical consumer.

The pressure booster can be connected to an external compressed air source via the compressed air inlet. In a vehicle repair operation, for example, there is the possibility to route the compressed air provided by a central compressor from connection points provided for this to the pressure booster, wherein hose lines typically suited for this are used, which are connected to the compressed air inlet. According to the invention, a compressed air generator is connected to the compressed air inlet, said generator also having compressed air flow through it when compressed air flows through the compressed air inlet and the system line connected to the compressed air inlet.

A distinguishing feature of the compressed air generator is that it produces electrical energy when a flow passes through it; this occurs, for example, by means of a generator wheel driven by the flow of compressed air. The electrical energy can be used to operate an internal and/or external electrical consumer. This can be functional components like a display unit, such as a display or a simple LED, a transmitting and receiving unit, an acoustic signaling unit such as a loudspeaker, a controller and/or feedback control unit, a measuring unit or suchlike. In the case of the supply for an internal consumer which is disposed on or in the pressure booster, said consumer is connected directly to the compressed air generator.

A connection unit, such as a plug unit, connected to the compressed air generator enables an external consumer to be supplied with the electrical energy produced by the compressed air generator. For this, the external consumer or functional component, for example a measuring unit or display unit disposed on the hydraulic tool, is connected to the compressed air generator using a suitable cable connection which can be connected to the connection element.

The inventive pressure booster makes it possible to operate any electrical functional components without the need for an external electric power source. Thus the pressure booster is able to be used in a particularly flexible manner which requires only the compressed air fundamentally necessary for its operation in order to produce energy.

The compressed air generator can basically be disposed at any position in the compressed air flow of the pressure booster. Direct connection with the compressed air inlet is also conceivable, for example, wherein the compressed air generator can then be disposed both upstream and downstream from the compressed air inlet. In the context of the invention, indications such as “behind,” “after” and “before” refer to the direction of the compressed air flow through the pressure booster.

However, according to an advantageous further embodiment of the invention, it is provided that the compressed air generator is connected to the system line with a generator inlet and a generator outlet. The system line is a pneumatic line disposed behind the compressed air inlet and connected to the compressed air inlet.

According to an advantageous further embodiment, the compressed air generator is integrated into the system line via a generator inlet and a generator outlet. According to a particularly advantageous embodiment of the invention, this generally makes the compressed air generator especially easy to arrange inside a housing of the pressure booster, where it is reliably protected from external influences. Moreover, no additional pneumatic lines are needed to connect the compressed air generator, so the pressure booster can be fabricated in a particularly space-saving, cost-effective manner.

Any design can basically be chosen for the connection unit to connect an external consumer. In one possible embodiment, the connection unit is formed by a separate plug unit to which the external functional components can be connected. According to a particularly advantageous further embodiment of the invention, however, it is provided that the connection unit is disposed at the hydraulic connection.

Accordingly, the hydraulic connection has integrated contacts for the electric power supply of the external functional components. This embodiment of the invention enables the use of such a connection line, which, along with conveyance of the hydraulic fluid, also has an electrical line for the electric power supply of the external functional components. Thus no separate electric power line is needed, which additionally improves the handling of the pressure booster. The coupling provided for the connection to the hydraulic connection also has connection contacts which are connected to the contacts disposed in the hydraulic connection when the coupling is installed on the hydraulic connection.

The internal electrical consumers or functional components can basically be designed in any manner according to the desired specifications for the power booster. According to a particularly advantageous embodiment, however, it is provided that the internal electrical consumer is formed by a battery, a data storage unit, a display unit and/or a communication unit for wireless data transmission.

According to an advantageous further development of the invention, the connection unit can be connected to a hydraulic tool connection unit disposed on the hydraulic tool. According to this embodiment, a hydraulic tool which can be connected to the pressure booster has its own hydraulic tool connection unit, which enables it to supply functional components with energy directly on the hydraulic tool. The hydraulic tool connection unit is designed for this according to the connection unit on the pressure booster and is connected to the compressed air generator in an electrically conductive manner. Here the connection can be direct or via a line connected to the connection unit on the pressure booster. The use of a hydraulic tool connection unit allows functional components to be used on the hydraulic tool to be connected directly on the hydraulic tool. Thus long feed lines to the functional components can be eliminated.

According to a further embodiment of the invention it is furthermore provided that the display unit has an e-paper display. The use of an e-paper display is distinguished by a low energy requirement. Furthermore, information on the display is also legible if there is no power supplied.

The pressure booster can fundamentally be of any design. Thus it can be designed as a module which is connected to the hydraulic tool via a flexible hose line. According to an advantageous embodiment of the invention, however, it is provided that the hydraulic unit and the pneumatic unit be combined as a single-piece, mobile handling unit designed for connecting a hydraulic tool directly to a coupling unit. The coupling unit enables an interchangeable, direct, rigid connection of the hydraulic tool without a flexible hydraulic line. The handling unit with a hydraulic tool connected is distinguished by small size and manageability.

Other features which are considered as characteristic for the invention are set forth in the appended claims.

Although the invention is illustrated and described herein as embodied in a pressure booster for driving hydraulic tools, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The figure shows a perspective view of a pressure booster according to the invention.

### DETAILED DESCRIPTION OF THE INVENTION

Referring now to the sole figure of the drawing in detail, there is shown an exemplary embodiment of a pressure booster 1 in a perspective view. The pressure booster 1 has a compressed air inlet 3 which is connected via a pneumatic system line 8 to an internal hydraulic unit, not shown here, in which the pneumatic pressure is converted to hydraulic pressure.

A compressed air generator 4 is integrated/inserted into the system line 8. The generator 4 has a generator inlet 6 and a generator outlet 7. The system line 8 is connected to the generator inlet 6 and to the generator outlet 7.

The compressed air generator 4 generates electric current when flow passes through it. The current is conducted, firstly, via an electrical line 10 to an internal electrical consumer 11 and, secondly, via another electrical line 10 to a connection unit 5a in the pressure booster housing 9. External electrical consumers, i.e. any functional components, can be supplied with current via the connection unit 5a. A further connection unit 5b is connected to the electrical consumer 11 via an electrical line 10, wherein the connection unit 5b is implemented as a digital output through which data stored in the electrical consumer can be read.

By way of example, the internal electrical consumer 11 may be one or more of a battery, a data storage unit, a display unit (preferably with a low-energy consumption display) and/or a communication unit for wireless data transmission.

Along with the connection possibility for connecting various functional components to the connection unit 5a, 5b, the pressure booster 1 also has a hydraulic connection 2 through which a hydraulic tool—not shown here—can be supplied with hydraulic pressure.

The following is a summary list of reference numerals and the corresponding structure used in the above description of the invention:

1 Pressure booster

2 Hydraulic connection

3 Compressed air inlet

4 Compressed air generator

5a, 5b Connection unit

6 Generator inlet

7 Generator outlet

8 System line

9 Pressure booster housing

10 Electrical line

11 Electrical consumer

1. A pressure booster for driving a hydraulic tool, the pressure booster comprising:
a gas or air pressure-driven pneumatic unit with a system line connected to a compressed air inlet;
a hydraulic unit connected to said pneumatic unit, said hydraulic unit having a hydraulic connection for a fluid-tight connection of the hydraulic tool to said hydraulic unit;
a compressed air generator connected to said compressed air inlet, said generator being connected to one or both of an internal electrical consumer or a connection unit for connecting an external electrical consumer.

2. The pressure booster according to claim 1, wherein said compressed air generator has a generator inlet connected to said system line and a generator outlet connected to said system line.

3. The pressure booster according to claim 1, which further comprises a pressure booster housing having said connection unit integrated therein.

4. The pressure booster according to claim 1, wherein said connection unit is disposed on said hydraulic connection.

5. The pressure booster according to claim 1, wherein said internal electrical consumer is at least one device selected from the group consisting of a battery, a data storage unit, a display unit and a communication unit for wireless data transmission.

6. The pressure booster according to claim 1, wherein said connection unit is configured for connection to a hydraulic tool connection unit disposed on the hydraulic tool.

7. The pressure booster according claim 1, wherein said internal electrical consumer is a display unit having an e-paper display.

8. The pressure booster according to claim 1, wherein said hydraulic unit and said pneumatic unit are combined in a single-piece, mobile handling unit.
